(19) United States
(12) Patent Application Publication
(10) Pub. No.: US 2006/0049771 A1
(43) Pub. Date: Mar. 9, 2006

(54) Instantaneous electronic ballast for metal halide lamp having state transition circuit

(75) Inventor: Seong-Jin Moon, Incheon-si (KR)

Correspondence Address: BIRCH STEWART KOLASCH & BIRCH, PO BOX 747, FALLS CHURCH, VA, 22040-0747, US

(73) Assignee: General Technology Corporation, Jeollabuk-Do (KR)

(21) Appl. No.: 10/543,160

(22) PCT Filed: Aug. 5, 2003
(86) PCT No.: PCT/KR03/01569

§ 371 Date: Jul. 25, 2005

(30) Foreign Application Priority Data
Feb. 26, 2003 (KR) 10-2003-0011954

(51) Int. Cl. H05B 37/02

(52) U.S. Cl. 315/209 R

(57) ABSTRACT

Disclosed is an electronic ballast for a metal halide lamp. In particular, the present invention relates to an instantaneous electronic ballast for a metal halide lamp, which allows instantaneous lightening of the lamp and can extend the life of the lamp. For this, the instantaneous electronic ballast includes a state transition circuit having a first capacitor, a first resistor and a first inductor that are sequentially serially connected between the output terminals of a power converter, for switching the output voltage of a rectifier that converts an AC power into a DC power to generate a voltage having a given frequency within a high frequency region, thus driving the metal halide lamp, and the input terminals of the metal halide lamp, for supplying a state transition current necessary to shift the metal halide lamp from a glow discharge phase to an arc discharge phase.

### TECHNICAL FIELD

The present invention relates to an electronic ballast for a metal halide lamp, and more particularly, to an instantaneous electronic ballast for a metal halide lamp which allows instantaneous lightening of the lamp, by supplying a state transition current that shifts the internal state of the lamp from a glow discharge state to an arc discharge state through an additional circuit when the metal halide lamp is initially turned on.

### BACKGROUND ART

In general, a metal halide lamp is a high pressure mercury discharge lamp containing a halogen compound. This lamp has a low mercury steam pressure before it is turned on. After the lamp is turned on, however, the mercury steam pressure is increased as temperature is increased within the lamp. If the mercury steam pressure reaches a normal state, the lamp has better properties in optical efficiency than a low pressure mercury discharge lamp.

The metal halide lamp has better optical properties than the low pressure discharge lamp, i.e., a high pressure sodium lamp (HPS) being a high pressure discharge lamp as well as a fluorescent lamp and a low pressure sodium lamp. In other words, major properties of the lamp are the general color rendering index representing the degree of color reproduction fidelity of a subject and luminous efficiency (lm/W) representing the correlation between the brightness and economy. From FIG. 1, it can be seen that the metal halide lamp has better optical properties than the fluorescent lamp, the low pressure sodium lamp and the high pressure sodium lamp (HPS). In view of the above, the use of the metal halide lamp is increased.

As above, the metal halide lamp having the good optical properties is turned on through the following operational phases. In other words, as shown in FIG. 2, the metal halide lamp is lightened through a breakdown phase where discharge is started, a glow discharge phase by collision of ions and an arc discharge phase by emission of hot electrons.

In other words, if the lamp voltage is continuously applied to both ends of the electrode in the metal halide lamp until the initial discharge voltage that breaks down a gas insulating status within the voltage is applied to both ends of the electrode, discharge is broken down. At this time, if a sufficient current is applied, the discharge uniformly occurs over the entire portion of the cathode electrode and the glow discharge phase where sonorous light is emitted is entered. In this period, the voltage between both ends of the lamp electrode is constantly kept for a given time regardless of variation in the current.

Thereafter, if more current is supplied, ionization within the lamp is further accelerated, which begins to heat the cathode. If the cathode's temperature reaches a given level, the cathode enters the hot electron discharge phase to reach the arc discharge phase where bright light is emitted.

FIG. 3 is a circuit diagram illustrating the construction of a conventional electronic ballast for lightening the metal halide lamp operated as above. A reference numeral 1 indicates an AC power. A rectifier 2 for converting the AC power into the DC power is connected between the output terminals of the AC power supply 1. A power converter 3 for switching the DC power outputted from the rectifier 2 to generate a voltage having a given frequency, is connected between the output terminals of the rectifier 2.

A metal halide lamp 4 is connected between the output terminals of the power converter 3. Further, there are provided a current sensor 5 for sensing a normal current and a state transition current, which are supplied to the metal halide lamp 4 (current to keep a lightening state of the lamp), and a power converter controller 6 for controlling the power converter 3 depending on the normal current or the state transition current sensed through the current sensor 5.

If the rectifier 2 of the electronic ballast constructed above converts the AC power into the DC power, the power converter 3 supplies the state transition current to the metal halide lamp 4. At this time, the supplied state transition current is sensed by the current sensor 5 of the power converter 3 and is then transmitted to the power converter controller 6.

As the metal halide lamp 4 has a state where the current does not flow into the lamp 4 before it is discharged, it looks like that the metal halide lamp 4 being a load is not connected, from the viewpoint of the power converter 3. If the metal halide lamp 4 is discharged, however, it becomes a discharge state and has a state where the current can flow into the lamp 4 being the load. At this time, the power converter 3 supplies the state transition current and the normal current to the metal halide lamp 4 being the load at the same time. Next, the two currents supplied by the power converter 3 are detected by the current sensor 5, which are then used as current control information of the power converter 3.

In the conventional electronic ballast for the metal halide lamp, the current profile for state transition when the lamp is initially lightened could not be adequately controlled. Therefore, there is a problem that instantaneous lightening of the metal halide lamp is difficult.

In other words, if the glow discharge state lasts for a long time, there is a problem that the life of the metal halide lamp is shortened, etc. For this reason, rapid transition from the glow discharge phase to the arc discharge phase is required. Due to this, the conventional electronic ballast has problems that instantaneous lightening of the metal halide lamp is difficult, and a problem that the life of the lamp is shortened cannot be overcome.

### DISCLOSURE OF INVENTION

Accordingly, the present invention has been made in view of the above problems, and it is an object of the present invention is to provide an instantaneous electronic ballast for a metal halide lamp, which allows instantaneous lightening of the lamp and can extend the life of the lamp, by supplying a state transition current through a state transition circuit capable of controlling the current profile of the state transition current that shifts the internal state of the lamp from a glow discharge state to an arc discharge state when the metal halide lamp is initially lightened.

To achieve the above objects, according to the present invention, there is provided an electronic ballast for a metal halide lamp having a power converter for switching the output voltage of a rectifier that converts an AC power into a DC power to generate a voltage having a given frequency within a high frequency region, thus driving the metal halide lamp, a current sensor for sensing the current to be used as current control information of the power converter, and a power converter controller for controlling the power converter in response to the sensed signal of the current sensor, including a state transition circuit having a first capacitor, a first resistor and a first inductor that are sequentially serially connected between the output terminals of the power converter and the input terminals of the metal halide lamp, for supplying a state transition current necessary to shift the metal halide lamp from the glow discharge phase to the arc discharge phase.

Further, the current sensor may be installed at the front of the state transition circuit to sense only a normal current being a current for keeping a lightening state of the lamp, which is applied from the power converter to the metal halide lamp.

In another aspect of the present invention, there is provided an instantaneous electronic ballast for a metal halide lamp having a power converter for switching the output voltage of a rectifier that converts an AC power into a DC power to generate a voltage having a given frequency within a high frequency region, thus driving the metal halide lamp, a current sensor for sensing the current to be used as current control information of the power converter, and a power converter controller for controlling the power converter in response to the sensed signal of the current sensor, including a state transition circuit having a second capacitor, second and third resistors that are connected in parallel, and a second inductor, all of which are sequentially serially connected between the output terminals of the power converter and the input terminal of the metal halide lamp, for supplying a state transition current necessary to shift the metal halide lamp from a glow discharge phase to an arc discharge phase.

In the above, the time constant of the second resistor through which a charge current flows from the power converter to the second capacitor may be set significantly higher than that of the third resistor through which a discharge current flows from the second capacitor to the metal halide lamp.

Further, the instantaneous electronic ballast for the metal halide lamp may further include second and third diodes for preventing backward voltages, which are serially connected on the input terminal' side of the second resistor through which a charge current flows from the power converter to the second capacitor, and the output terminal' side of the third resistor through which a discharge current flows from the second capacitor to the metal halide lamp, respectively.

Furthermore, the current sensor may be installed at the front of the state transition circuit to sense only the normal current being the current for keeping the lightening state of the lamp that is applied from the power converter to the metal halide lamp.

### BRIEF DESCRIPTION OF THE DRAWINGS

Further objects and advantages of the invention can be more fully understood from the following detailed description taken in conjunction with the accompanying drawings in which:

FIG. 1 is a graph illustrating optical properties of a conventional lamp,

FIG. 2 is a graph illustrating phases in which an electronic ballast for a common metal halide lamp is lightened,

FIG. 3 is a circuit diagram illustrating the operation of the electronic ballast for a conventional metal halide lamp,

FIG. 4 is a circuit diagram illustrating the construction of an electronic ballast according to a first embodiment of the present invention,

FIG. 5 is a circuit diagram illustrating the construction of an electronic ballast according to a second embodiment of the present invention, and

FIG. 6 is a circuit diagram illustrating the construction of an electronic ballast according to a third embodiment of the present invention.

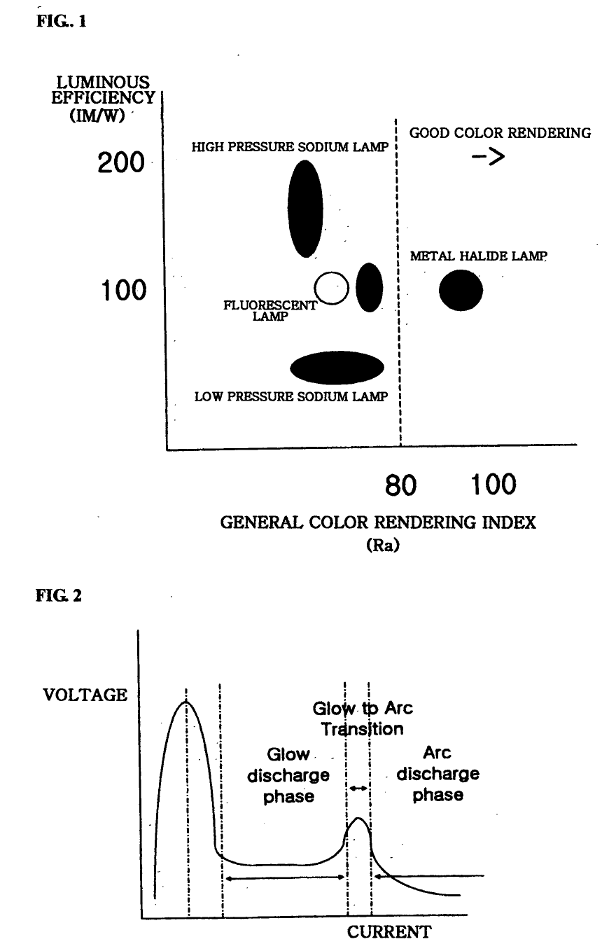

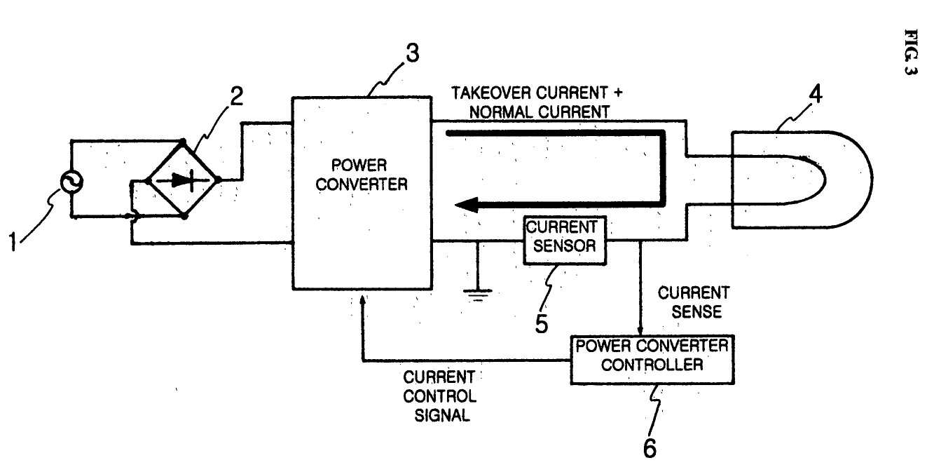

### BEST MODE FOR CARRYING OUT THE INVENTION

The present invention will now be described in detail in connection with preferred embodiments with reference to the accompanying drawings.

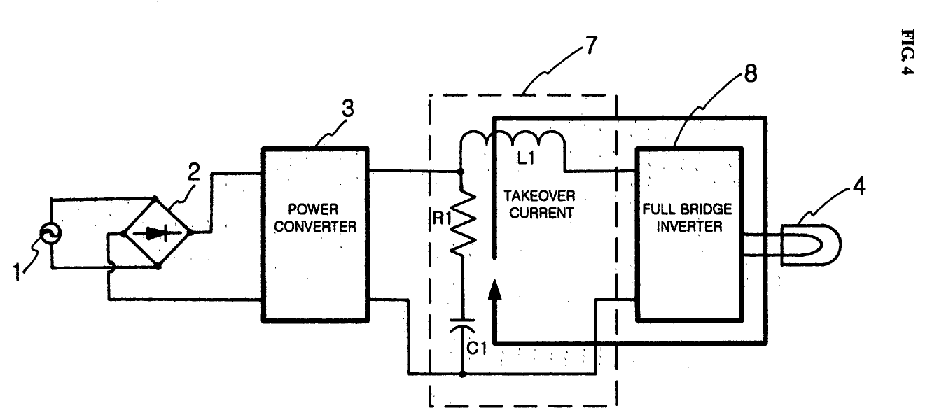

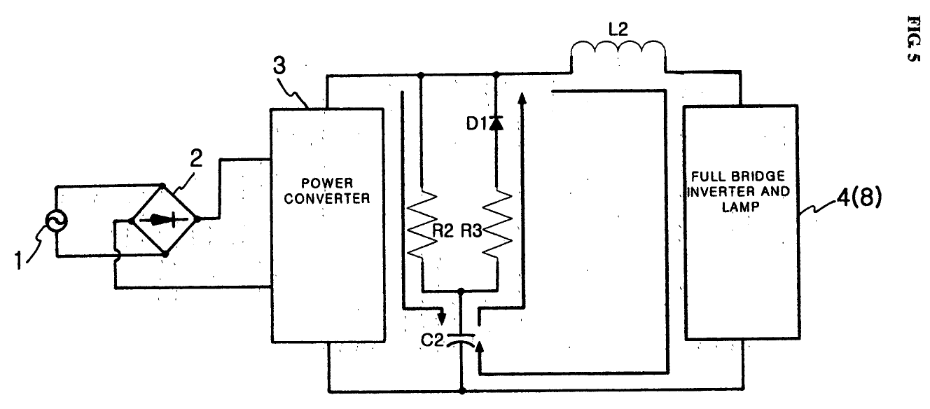

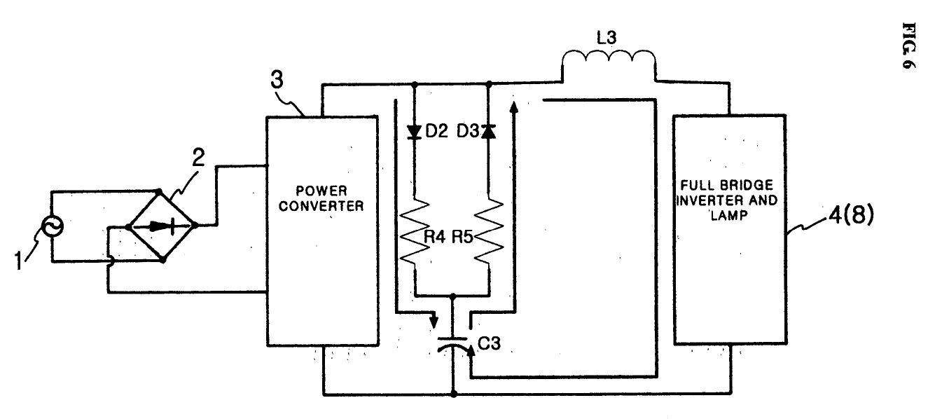

FIG. 4˜FIG. 6 are circuit diagrams illustrating the constructions of instantaneous electronic ballasts for metal halide lamps according to several embodiments of the present invention, in which like reference numerals are used to identify the same or similar parts.

FIG. 4 is the circuit diagram illustrating the construction of the instantaneous electronic ballast for the metal halide lamp according to the first embodiment of the present invention.

A rectifier 2 for converting the AC power into the DC power is connected between the output terminals of an AC power supply 1. A power converter 3 for switching the DC power of the rectifier 2 to generate a voltage having a given frequency within a high frequency region is connected between the output terminals of the rectifier 2.

Further, a state transition circuit 7 of the present invention for supplying a state transition current necessary to shift the lamp 4 from a glow discharge phase to an arc discharge phase, is connected between the output terminals of the power converter 3 and the input terminals of a metal halide lamp 4. The state transition circuit 7 has a first capacitor C1, a first resistor R1 and a first inductor L1, which are sequentially serially connected. The profile of the state transition current of the metal halide lamp 4 can be adequately controlled by properly setting the time constants of the first capacitor C1, the first resistor R1 and the first inductor L1.

In FIG. 4, an unexplained reference numeral 8 indicates a full bridge inverter for inverting the polarity of the voltage applied to the metal halide lamp 4.

The method of operating the instantaneous electronic ballast for the metal halide lamp constructed above will now be described.

Before the metal halide lamp 4 is discharged, the first capacitor C1 of the state transition circuit 7 is charged with a voltage same to the output voltage of the rectifier 2. If the metal halide lamp 4 being a load has a state where the current can flow into the lamp 4, however, the voltage at both ends of the metal halide lamp becomes significantly lower than the charge voltage of the first capacitor C1. Therefore, as the voltage of the first capacitor C1 is higher than the voltage at both ends of the metal halide lamp 4 being the load, the voltage charged into the first capacitor C1 is discharged toward the metal halide lamp 4.

At this time, the current that is provided to the metal halide lamp 4 by the first capacitor C1 serves as the state transition current. The profile of the current that is applied to the metal halide lamp 4 by the first capacitor C1 is varied depending on the time constants of the first capacitor C1, the first resistor R1 and the first inductor L1. Therefore, the profile of the state transition current can be controlled to be suitable for instantaneous lightening of the metal halide lamp 4 by properly adjusting the time constant values.

As above, if the metal halide lamp 4 enters the arc discharge phase where a bright light is emitted due to the application of the state transition current, the normal current for keeping the lightening state of the metal halide lamp 4 is supplied to the metal halide lamp 4 via the power converter 3. Thus, the lamp 4 maintains the lightening state.

Meanwhile, a current sensor 5 may be installed at the front and rear of the state transition circuit 7. If the current sensor 5 is installed at the front of the state transition circuit 7, only the normal current applied to the metal halide lamp 4 is sensed by the current sensor 5. The sensed normal current is used as current control information of the power converter 3.

On the contrary, if the current sensor 5 is installed at the rear of the state transition circuit 7, both the state transition current and the normal current applied to the metal halide lamp 4 are sensed by the current sensor 5. According to experimental results, however, it was found that the case where the current sensor 5 is installed at the front of the state transition circuit 7 improves the efficiency of the ballast.

FIG. 5 is the circuit diagram illustrating the construction of the instantaneous electronic ballast for the metal halide lamp according to the second embodiment of the present invention. The instantaneous electronic ballast shown in FIG. 5 has the same construction to those shown in FIG. 4 except for the construction of the state transition circuit installed between the output terminals of the power converter 3 and the input terminals of the metal halide lamp 4. Therefore, detailed explanation on it will be omitted in order to avoid redundancy.

As shown in FIG. 5, the state transition circuit has a second capacitor C2, second and third resistors R2 and R3 that connected in parallel, and a second inductor L2, all of which are sequentially serially connected. The time constant of the second resistor R2 through which a charge current flows from the power converter 3 to the second capacitor C2, is set significantly higher than the time constant of the third resistor R3 through which a discharge current flows from the second capacitor C2 to the metal halide lamp 4. A first diode D1 for preventing the backward voltage is serially connected to the output terminal of the third resistor R3.

Accordingly, if the second capacitor C2 is charged with the voltage, the charge current flows from the power converter 3 to the second capacitor C2 through the second resistor R2. If the metal halide lamp 4 is discharged, the voltage charged into the second capacitor C2 is higher than the voltage at both ends of the lamp being the load. Thus, the voltage charged into the second capacitor C2 is discharged toward the lamp 4 through the second and third resistors R2 and R3. At this time, as the time constant of the second resistor R2 is significantly higher than the time constant of the third resistor R3, most of the discharge currents discharged from the second capacitor C2 are applied to the metal halide lamp 4 being the load through the third resistor R3, whereby the state of the metal halide lamp 4 is shifted.

FIG. 6 is the circuit diagram illustrating the construction of the instantaneous electronic ballast for the metal halide lamp according to the third embodiment of the present invention. The instantaneous electronic ballast shown in FIG. 6 has the same construction to those shown in FIGS. 4 except for the construction of the state transition circuit installed between the output terminals of the power converter 3 and the input terminals of the metal halide lamp 4. Therefore, detailed explanation on it will be omitted in order to avoid redundancy.

As shown in FIG. 6, a state transition circuit has a third capacitor C3, fourth and fifth resistors R4 and R5 that are connected in parallel, and a third inductor L3, all of which are sequentially serially connected. Second and third diodes D2 and D3 for preventing backward voltages are serially connected on the input terminal' side of the fourth resistor R4 through which the charge current flows from the power converter 3 to the third capacitor C3, and the output terminal' side of the fifth resistor R5 through which the discharge current flows from the third capacitor C3 to the metal halide lamp 4, respectively.

Accordingly, if the third capacitor C3 is charged with the voltage, the charge current flows from the power converter 3 to the third capacitor C3 through the second diode D2 and the fourth resistor R4. If the metal halide lamp 4 is discharged, however, the voltage charged into the third capacitor C3 is higher than the voltage at both ends of the lamp being a load. Therefore, the voltage charged into the third capacitor C3 is supplied to the metal halide lamp 4 being the load through the fifth resistor R5 and the third diode D3, whereby the state of the metal halide lamp 4 is shifted.

### INDUSTRIAL APPLICABILITY

As described above, according to the present invention, the present invention includes an additional state transition circuit for supplying a state transition current that shifts an internal state of a metal halide lamp from a glow discharge state to an arc discharge state when the lamp is initially lightened. A normal current for maintaining a lightening state of the metal halide lamp is applied through the power converter, and only a state transition current necessary for state transition is applied through the state transition circuit. At this time, the current profile of the state transition current can be controlled by adequately setting the time constant of the state transition circuit. Therefore, the present invention has new effects that it allows instantaneous lightening of the metal halide lamp and can improve the life of the lamp.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An instantaneous electronic ballast for a metal halide lamp having a power converter for switching the output voltage of a rectifier that converts an AC power into a DC power to generate a voltage having a given frequency within a high frequency region, thus driving the metal halide lamp, a current sensor for sensing a current to be used as current control information of the power converter, and a power converter controller for controlling the power converter in response to the sensed signal of the current sensor, comprising:
a state transition circuit having a first capacitor, a first resistor and a first inductor that are sequentially serially connected between the output terminals of the power converter and the input terminals of the metal halide lamp, for supplying a state transition current necessary to shift the metal halide lamp from a glow discharge phase to an arc discharge phase.

2. The instantaneous electronic ballast for the metal halide lamp as claimed in claim 1 wherein the current sensor is installed at the front of the state transition circuit to sense only a normal current being a current for keeping a lightening state of the lamp, which is applied from the power converter to the metal halide lamp.

3. An instantaneous electronic ballast for a metal halide lamp having a power converter for switching the output voltage of a rectifier that converts an AC power into a DC power to generate a voltage having a given frequency within a high frequency region, thus driving the metal halide lamp, a current sensor for sensing a current to be used as current control information of the power converter, and a power converter controller for controlling the power converter in response to the sensed signal of the current sensor, comprising:
a state transition circuit having a second capacitor, second and third resistors that are connected in parallel, and a second inductor, all of which are sequentially serially connected between the output terminals of the power converter and the input terminal of the metal halide lamp, for supplying a state transition current necessary to shift the metal halide lamp from a glow discharge phase to an arc discharge phase.

4. The instantaneous electronic ballast for the metal halide lamp as claimed in claim 3, wherein the time constant of the second resistor through which a charge current flows from the power converter to the second capacitor is set significantly higher than that of the third resistor through which a discharge current flows from the second capacitor to the metal halide lamp.

5. The instantaneous electronic ballast for the metal halide lamp as claimed in claim 3, further comprising second and third diodes for preventing backward voltages, which are serially connected on the input terminal' side of the second resistor through which a charge current flows from the power converter to the second capacitor, and the output terminal' side of the third resistor through which a discharge current flows from the second capacitor to the metal halide lamp, respectively.

6. The instantaneous electronic ballast for the metal halide lamp as claimed in claims 3˜5, wherein the current sensor is installed at the front of the state transition circuit to sense only the normal current being the current for keeping the lightening state of the lamp that is supplied from the power converter to the metal halide lamp.
